(19) United States
(12) Patent Application Publication
(10) Pub. No.: US 2013/0239200 A1
(43) Pub. Date: Sep. 12, 2013

(54) ELECTRONIC DEVICE AND METHOD FOR OPERATING LOCKED TOUCH SCREENS

(71) Applicant: CHI MEI COMMUNICATION SYSTEMS, INC., New Taipei (TW)

(72) Inventor: CHING-WEN HSUEH, New Taipei (TW)

(73) Assignee: CHI MEI COMMUNICATION SYSTEMS, INC., New Taipei (TW)

(21) Appl. No.: 13/756,560

(22) Filed: Feb. 1, 2013

(30) Foreign Application Priority Data
Mar. 7, 2012 (TW) 101107568

(51) Int. Cl. G06F 21/00

(52) U.S. Cl. CPC G06F 21/00
USPC 726/16

(57) ABSTRACT

An electronic device and a method are used to operate a locked touch screen of the electronic device. A password of unlocking the locked touch screen is set and stored into a storage device of the electronic device. When touches are generated on the touch screen, a count of touch points of each of the touches is obtained to generate a number queue. The number queue is compared with the password stored in the storage device, and the touch screen is unlocked when the number queue is identical to the password.

### BACKGROUND

1. Technical Field

Embodiments of the present disclosure relate to user interfaces that employ touch-sensitive displays, and more particularly to a method for unlocking and dialing using the unlocked touch screens.

2. Description of Related Art

Touch screens are popular for use as displays and user input devices on portable devices, such as mobile telephones and personal digital assistants (PDAs). One problem associated with using the touch screens on the portable devices is the unintentional activation or deactivation of functions due to unintentional contact with the touch screens. Thus, the touch screens on such devices, and/or applications running on such devices may be locked upon satisfaction of predefined lock conditions, such as ending an active call, or after a predetermined time of idleness has elapsed, or upon manual locking by a user.

Devices with the touch screens and/or applications running on such devices may be unlocked by, for example, slide to unlock. Such unlock procedure, however, has drawbacks, such as, unintentionally unlocking. In addition, in the locking condition, it is inconvenient to dial emergency telephone numbers, such as 112, 911.

### BRIEF DESCRIPTION OF THE DRAWINGS

FIG. 1 is a block diagram of one embodiment of an electronic device including a touch screen operating system.

FIG. 2 is a block diagram of one embodiment of function modules of the touch screen operating system in FIG. 1.

FIG. 3 illustrates a flowchart of one embodiment of a method for setting unlocking passwords.

FIG. 4 illustrates a flowchart of one embodiment of a method for operating locked touch screens including unlocking the locked touch screens and dialing using the locked touch screen.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

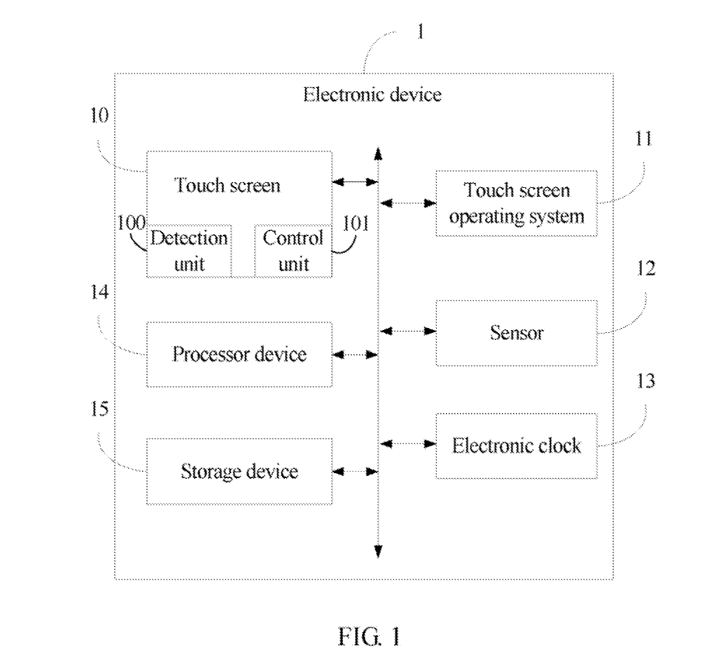

FIG. 1 is a block diagram of one embodiment of an electronic device 1 including a touch screen operating system 11. The electronic device 1 may be, for example, a smart phone, a computer, or a personal digital assistant (PDA) that is installed with a touch screen 10. The touch screen 10 is a multi-touch screen. The touch screen 10 includes a detection unit 100 and a control unit 101. The detection unit 100 detects presences and location information of touch points within a display area on the touch screen 10, and sends the location information of the touch points to the control unit 101. The control unit 101 generates data as to the coordinates of the touch and then sends the coordinate to the touch screen operating system 11.

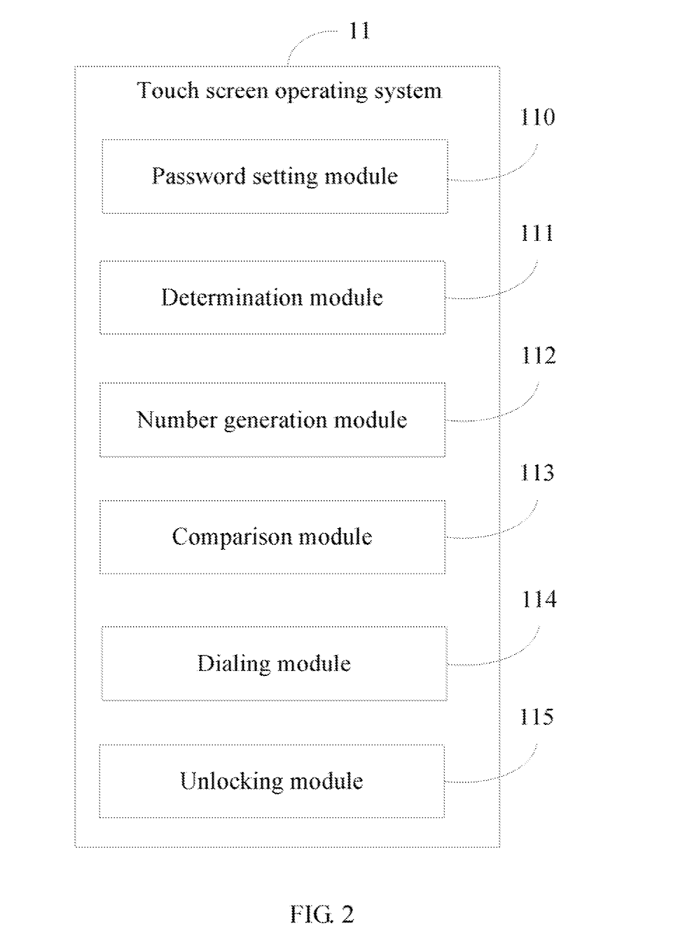

The touch screen operating system 11 includes a plurality of function modules (see FIG. 2 below), which include computerized code when executed to provide a method of unlocking the touch screen 10 and dialing using the touch screen 10 when the touch screen 10 is locked.

The electronic device 1 further includes a sensor 12. After the touch screen 10 being locked, the electronic device 1 may enter into a sleep mode after a predetermined time of inactivity has elapsed. The sensor 12 detects whether an awaken condition of the electronic device 1 is triggered when the electronic device 1 is in the sleep mode. After the awaken condition is triggered, the electronic device 1 enters a locked working mode. The awaken condition may be triggered when a predetermined physical button of the electronic device 1 is pressed, for example. The electronic device 1 may further include an electronic clock 13.

In addition, the electronic device 1 includes a processor device 14. The processor device 14 may include a processor, a microprocessor, an application-specific integrated circuit (ASIC), and a field programmable gate array (FPGA), for example. The processor device 14 may execute the computerized code of the function modules of the touch screen operating system 11 to realize functions of the touch screen operating system 11.

Furthermore, the electronic device 1 includes a storage device 15. The storage device 15 may include any type(s) of non-transitory computer-readable storage medium, such as a hard disk drive, a compact disc, a digital video disc, or a tape drive. The storage device 15 stores the computerized code of the function modules of the touch screen operating system 11.

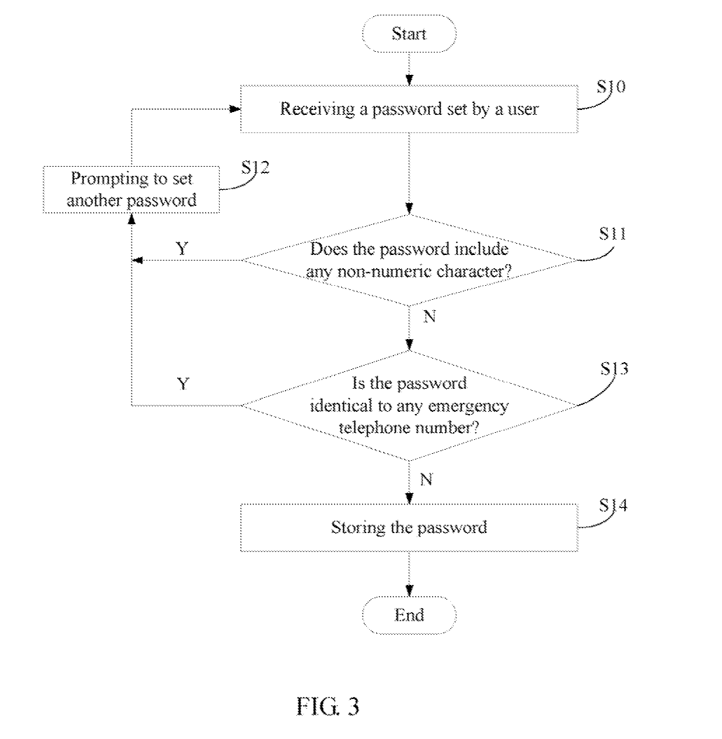

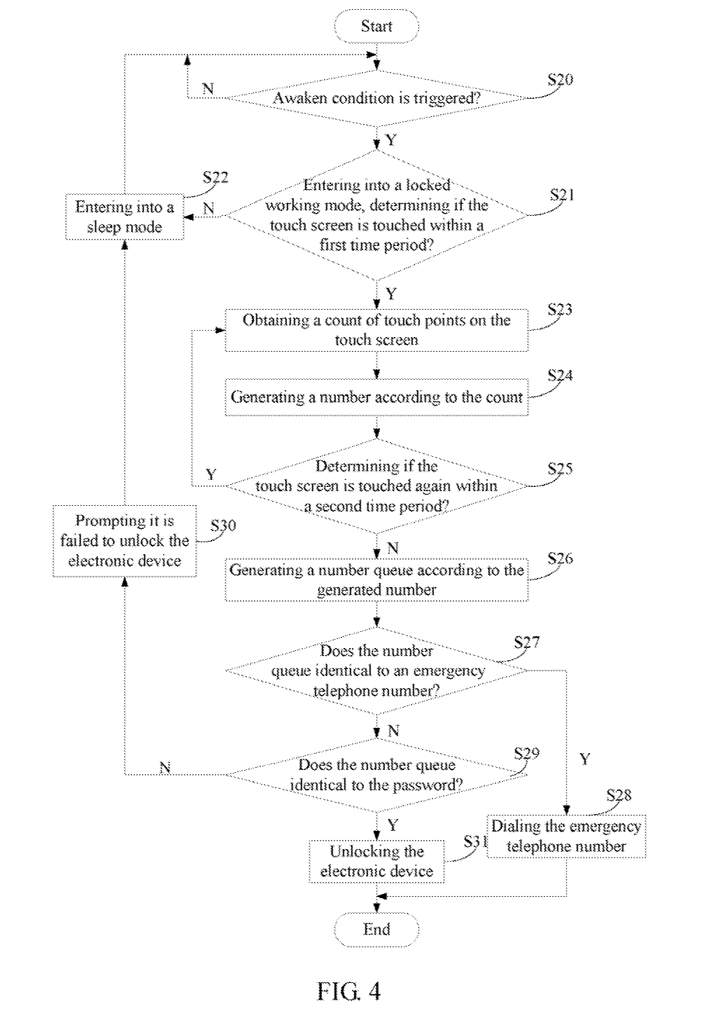

FIG. 2 is a block diagram of one embodiment of the function modules of the touch screen operating system 11. In one embodiment, the function modules may include a password setting module 110, a determination module 111, a number generation module 112, a comparison module 113, a dialing module 114, and an unlocking module 115. The functions of the function modules 110-115 are illustrated in FIG. 3 and FIG. 4 and described below.

FIG. 3 illustrates a flowchart of one embodiment of a method for setting unlocking passwords. Depending on the embodiment, additional steps may be added, others removed, and the ordering of the steps may be changed.

In step S10, the password setting module 110 receives a password set by a user. In one embodiment, the password setting module 110 provides a password setting box to receive the password set by the user.

In step S11, the password setting module 110 determines if the set password includes any non-numeric character, such as, letters of the alphabet and punctuation symbol. In the present application, a valid password is composed of one or more Arabic numerals. Thus, if the set password includes any non-numeric character, step S12 is implemented. Otherwise, if the set password only includes one or more Arabic numerals, step S13 is implemented.

In step S12, the password setting module 110 prompts the user to set another password that should include one or more Arabic numerals.

In step S13, the password setting module 110 further determines if the set password set is identical to any emergency telephone number, such as 112, or 911, for example. If the set password is identical to any emergency telephone number, the above described step S12 is implemented. Otherwise, if the set password is different from any emergency telephone number, step S14 is implemented. In one embodiment, the storage device 15 may store all the emergency telephone numbers. The password setting module 110 matches the set password with the emergency telephone numbers stored in the storage device 15 to determine if the set password is identical to any emergency telephone number

In step S14, the password setting module 110 stores the password set by the user into the storage device 15.

FIG. 4 illustrates a flowchart of one embodiment of a method for operating locked touch screens including unlocking the locked touch screens and dialing the locked touch screen. Depending on the embodiment, additional steps may be added, others removed, and the ordering of the steps may be changed.

In step S20, the determination module 111 determines whether an awaken condition of the electronic device 1 is triggered. In one embodiment, when the electronic device is in a sleep mode, and the sensor 13 detects the awaken condition of the electronic device 1, and sends a trigger signal to the determination module 111 when the awaken condition is triggered. The awaken condition may be triggered when a predetermined physical button of the electronic device 1 is pressed. If the awaken condition of the electronic device 1 is triggered, step S21 is implemented. Otherwise, until the awaken condition of the electronic device 1 is triggered, step S20 is repeated.

In step S21, the electronic device 1 enters into a locked working mode, and the determination module 111 further determines if the touch screen 10 is touched within a first time period according to the electronic clock 13. In one embodiment, the first time period may be 1 minute, and begins at the time of the awaken condition of the electronic device 1 is triggered. For example, when the awaken condition of the electronic device 1 is triggered at 9:00, the first time period may be from 9:00 to 9:01. As mentioned, the detection unit 100 of the touch screen 10 detects the presences and location information of touch points within a display area on the touch screen 10, and the control unit 101 of the touch screen 10 generates data as to the coordinates of the touch points, and then sends the coordinates to the touch screen operating system 11. The determination module 111 determines that the touch screen 10 is touched when receiving the data of the coordinates during the first time period, and then step S23 is implemented. If the touch screen 10 is not touched within the first time period, in step S22, the electronic device 1 enters into the sleep mode again, and until a touch takes place, steps S20 to S22 are repeated.

In step S23, the number generation module 112 obtains a count of the touch points on the touch screen 10. For example, if the user touches the touch screen 10 with five fingers, then the count of the touch points on the touch screen 10 is 5.

In step S24, the number generation module 112 generates a number according to the count of the touch points. For example, if the count of the touch points is 5, then the generated number is 5. The generated number can be stored into the storage device 15 temporarily.

In step S25, the number generation module 112 determines if the touch screen 10 is touched again within a second time period. The second time period may be 1 minute for example, and begins at the time when the user removes his fingers from the touch screen 10. Steps S23 to S24 is repeated if the touch screen 10 is touched again within the second time period. Otherwise, step S26 is implemented when the second time period has expired.

In step S26, the number generation module 113 generates a number queue according to the one or more generated numbers. In one embodiment, for example, if the first generated number is 1, the second generated number is 2, the third generated number is 3, the fourth generated number is 4, and the fifth generated number is 5, the number queue is “12345”.

In step S27, the comparison module 113 compares the number queue with the emergency telephone numbers to determine if the number queue is identical to an emergency telephone number. Step S28 is implemented if the number queue is identical to an emergency telephone number. Otherwise, step S29 is implemented if the number queue is different from any emergency telephone number.

In step S28, the dialing module 114 dials the emergency telephone number when the touch screen 10 of the electronic device 1 is locked. In addition, a physical or virtual button is provided in the electronic device 1 to hang-up mistaken dialing of the emergency number.

In step S29, the comparison module 113 compares the number queue with the password stored in the storage device 15 to determine if the number queue is identical to the password. If the number queue is different from the password, in step S30, the unlocking module 115 prompts the user that it is failed to unlock the touch screen 10 of the electronic device 1. Otherwise, if the number queue is identical to the password, in step S31, the unlocking module 115 unlocks the touch screen 10 of the electronic device 1.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for operating a locked touch screen of an electronic device being performed by execution of computerized codes by a processor of the electronic device, the method comprising:
setting a password of unlocking the touch screen, and storing the password into a storage device of the electronic device;
obtaining one or more counts of touch points of touches on the touch screen, generating one or more number according to the count(s), and generating a number queue according to the one or more numbers;
comparing the number queue with the password stored in the storage device to determine if the number queue is identical to the password; and
unlocking the locked touch screen of the electronic device when the number queue is identical to the password.

2. The method according to claim 1, wherein the setting step includes:
receiving the password set by a user, and determining if the password include any non-numeric character; and
prompting the user to set another password when the password include any non-numeric character.

3. The method according to claim 1, before comparing the number queue with the password, the method further comprising:
comparing the number queue with emergency telephone numbers to determine if the number queue is identical to an emergency telephone number; and
dialing the emergency telephone when the number queue is identical to the emergency telephone number.

4. The method according to claim 3, wherein the setting step includes:
determining if the password is identical to any emergency telephone number; and
prompting the user to set another password when the password is identical to any emergency telephone number.

5. An electronic device, comprising:
a touch screen;
a non-transitory storage device;
at least one processing device; and
one or more modules that are stored in the non-transitory storage device and executed by the at least one processing device, the one or more modules comprising instructions to:
set a password of unlocking the touch screen, and store the password into the non-transitory storage device;
obtain one or more counts of touch points of touches on the touch screen, generate one or more numbers according to the count(s), and generate a number queue according to the one or more numbers;
compare the number queue with the password stored in the non-transitory storage medium to determine if the number queue is identical to the password; and
unlock the touch screen of the electronic device when the number queue is identical to the password.

6. The electronic device according to claim 5, wherein the one or more modules comprise instructions to:
receive the password set by a user, and determine if the password include any non-numeric character; and
prompt the user to set another password when the password include any non-numeric character.

7. The electronic device according to claim 5, wherein the one or more modules further comprises instructions to:
comparing the number queue with emergency telephone numbers to determine if the number queue is identical to an emergency telephone number; and
dialing the emergency telephone when the number queue is identical to the emergency telephone number.

8. The electronic device according to claim 7, wherein the one or more modules further comprises instructions to:
determine if the password is identical to any emergency telephone number; and
prompt the user to set another password when the password is identical to any emergency telephone number.

9. A non-transitory storage medium having stored thereon instructions that, when executed by a processor of an electronic device, causes the processor to perform a method for operating a locked touch screen of the electronic device, wherein the method comprises:
setting a password of unlocking the touch screen, and storing the password into a storage device of the electronic device;
obtaining one or more counts of touch points of touches on the touch screen, generating one or more number according to the count(s), and generating a number queue according to the one or more numbers;
comparing the number queue with the password stored in the storage device to determine if the number queue is identical to the password; and
unlocking the locked touch screen of the electronic device when the number queue is identical to the password.

10. The storage medium according to claim 9, wherein the setting step includes:
receiving the password set by a user, and determining if the password include any non-numeric character; and
prompting the user to set another password when the password include any non-numeric character.

11. The storage medium according to claim 9, before comparing the number queue with the password, wherein the method further comprises:
comparing the number queue with emergency telephone numbers to determine if the number queue is identical to an emergency telephone number; and
dialing the emergency telephone when the number queue is identical to the emergency telephone number.

12. The storage medium according to claim 11, wherein the setting step includes:
determining if the password is identical to any emergency telephone number; and
prompting the user to set another password when the password is identical to any emergency telephone number.
